(19) United States
(12) Patent Application Publication
(10) Pub. No.: US 2013/0191309 A1
(43) Pub. Date: Jul. 25, 2013

(54) Dataset Compression

(71) Applicant: Choudur Lakshminarayan, Austin, TX (US)

(72) Inventor: Choudur Lakshminarayan, Austin, TX (US)

(21) Appl. No.: 13/825,043

(22) PCT Filed: Oct. 14, 2010
(86) PCT No.: PCT/US10/52708

§ 371 Date: Mar. 19, 2013

(51) Int. Cl. G06Q 40/06

(52) U.S. Cl. CPC G06Q 40/06
USPC 705/36 R; 708/203

(57) ABSTRACT

Compression of an initial dataset is implemented on a data processing system. The initial dataset can be transformed (210) into a group of initial wavelet coefficients using a wavelet basis function. Magnitudes of initial wavelet coefficients in the group of initial wavelet coefficients can be calculated (220). Initial wavelet coefficients having magnitudes beyond a cutoff value can be deleted (230). A compressed group of wavelet coefficients can be identified (240) from the wavelet coefficients remaining within the cutoff value. The initial dataset can be approximated (250) using the compressed group of wavelet coefficients and the wavelet basis function.

### BACKGROUND

Enterprises often use econometric modeling to determine how various investments affect revenue or other variables. For example, historical revenue may be used as a response variable with historical marketing investments used as predictors to find which marketing investments were significant drivers of revenue. Some examples of marketing investments an enterprise may make include direct marketing, telemarketing, sales, enablers, marketing development funds (MDF), channel support, and so forth. Enterprises often desire to identify market drivers or predict revenues based on marketing or other investments across product lines, business units, countries, and geographies.

### BRIEF DESCRIPTION OF THE DRAWINGS

FIG. 1 is a flow diagram of a method for estimating revenues based on marketing investments in accordance with an example;

FIG. 2 is a flow diagram of a method for compression of art initial dataset in accordance with an example;

FIG. 3 is a flow diagram of a method for compression of a dataset using cumulative distributions and determination of quantile values in accordance with an example; and

FIG. 4 is a block diagrams of a system for compressing an initial dataset in accordance with an example.

### DETAILED DESCRIPTION

Reference will now be made to the examples illustrated, and specific language will be used herein to describe the same. It will nevertheless be understood that no limitation of the scope of the technology is thereby intended. Additional features and advantages of the technology will be apparent from the detailed description which follows, taken in conjunction with the accompanying drawings, which together illustrate, by way of example, features of the technology.

Marketing and sales data typically includes trends, jumps, and seasonality (periodic) and ultimately includes a degree of noise. Various methods have been employed to extract relevant information from marketing and sales data. This relevant information can then be used in allocation of marketing resources to more successfully drive revenue. Some methods of extracting relevant and useful information from marketing or sales data have included transforming the data, such as by using a Fourier transform. Fourier transforms can extract periodic features from the data.

Fourier transforms are limited in application for extracting relevant information from sales and marketing data because a single analysis window or time frame cannot detect features in signals in the data where the features are much longer or much shorter than the window size. As a result, Short-Term Fourier Transforms (STFTs) have been developed which slide a fixed-size analysis window along a time axis. STFTs are able to detect non-stationarities, signals, or processes where a probability distribution changes when shifted in time or space. However, the fixed size window of STFTs limits the detection of signal cycles in the data. Wavelengths that are longer than the analysis windows are generally not detected using STFT. Also, stationarity (or lack thereof) in short wavelength signals (i.e., high frequency) is not typically detected using STFT.

Wavelets are mathematical functions that can divide input data into different frequency components. Wavelets can be used to analyze each of the components at a resolution matched to a scale of the component Wavelets are sometimes used in analyzing situations where a signal contains discontinuities and sharp spikes. Wavelets are also sometimes used for data compression, such as image compression, video compression, audio compression, etc. Wavelets can be used in these examples to store data it a minimal space in a file. Wavelet compression, can be either lossless or lossy. Wavelet compression is often not viewed as good for all kinds of data. For example, transient signal characteristics can indicate a good wavelet compression while smooth, periodic signals may be more suitably compressed by other methods, such as Fourier transforms or other methods.

In wavelet analysis, typically an analyzing wavelet will be used. Temporal analysts can be performed with a contracted, high-frequency version of the analyzing wavelet, and frequency analysis can be performed with a dilated, low-frequency version of a same wavelet. Because the original, signal or function can be represented in terms of a wavelet expansion, data operations can be performed using just the corresponding wavelet coefficients. If select wavelets are adapted to the data being analyzed, the data can be sparsely represented using the wavelets.

The present technology describes the use of a suitable wavelet function selected from a suitable wavelet library (such as a wavelet packet library) and the application of energy based thresholding methods to capture bumps, breaks and trends in data. The present technology can be used for obtaining compression of the data in a manner that can attenuate noise from the data such that a signal portion of the data can be elucidated. A specific application of the noise attenuation using wavelets as described below includes econometric modeling. Downstream econometric modeling can be reliable, statistically significant, and can properly relate predictor variables (such as marketing investments, for example) with response variables (such as revenue, for example). This model can be used for determining drivers of sales and revenue. Also, the model can be used as an objective function of revenue with constraints on marketing investments for optimal allocation of marketing resources.

Marketing and sales data can include trends, jumps, and seasonality (periodic) and can ultimately be noisy. One approach to tease out relevant information from a time series of sales/marketing data is to transform the data. Use of a wavelet transform can address some of the inefficiencies of Fourier transforms by using narrow windows at high frequencies, and wide windows at low frequencies. Thus, a wavelet analysis can enable localization of data.

For a time-series analysts of return on marketing investments, the capacity of a one-dimensional wavelet transform can be utilized for analyzing periodic signals, gradual shifts, and abrupt changes and interruptions (i.e., discontinuities). The present technology provides a regression model which is fit to the data to find significant drivers of revenue. For example, in typical econometric modeling, revenue may be used as a response variable and marketing investments (such as investments in direct marketing, telemarketing, sales, enablers, marketing development funds (MDF), channel support, and so forth) can be used as predictive variables.

Generally, the systems and methods can smooth marketing research data by using wavelet transformation. Noise can be attenuated from the data such that a signal portion of the data is enhanced. The data can be pre-processed in a way that results in an econometric modeling which is reliable, statistically significant, and wherein marketing investments are properly related with revenues.

In an example, compression of an initial dataset is implemented on a data processing system. The initial dataset can be transformed into a group of initial wavelet coefficients using a wavelet basis function. When discrete wavelets are used to transform a signal, the result can be a series of wavelet coefficients. Magnitudes of initial wavelet coefficients in the group of initial wavelet coefficients can be calculated. The magnitudes of the squares of wavelet coefficients can be referred to as an “energy” of the wavelet coefficients. Initial wavelet coefficients having magnitudes or energies beyond a cutoff value can be deleted (i.e., removed from the group of initial wavelet coefficients). A compressed group of wavelet coefficients cart be identified from the wavelet coefficients remaining within the cutoff value. The initial dataset can be approximated using the compressed group of wavelet coefficients and the wavelet basis function.

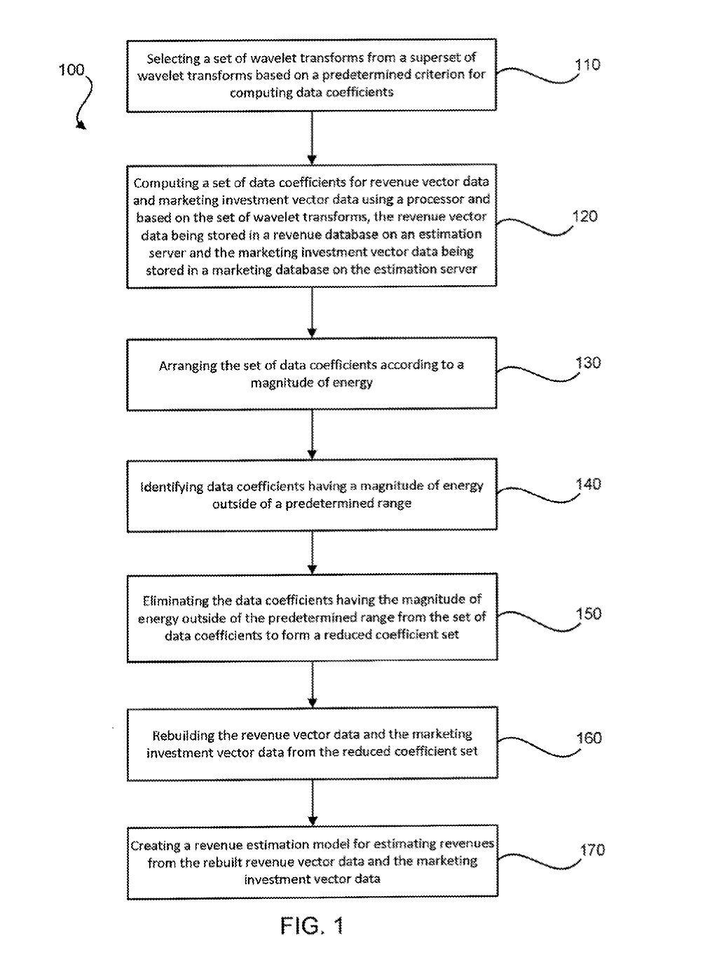

Referring to FIG. 1, a more specific example related directly to marketing and revenue data for econometric modeling is shown in which a method 100 is provided for estimating revenues based on marketing investments. A set of wavelet transforms can be selected 110 from a superset of wavelet transforms based on a predetermined criterion for computing data coefficients. A set of data coefficients for revenue vector data and marketing investment vector data can be computed 120 using a processor. The computation of the set of data coefficients can be based on the set of wavelet transforms, the revenue vector data being stored in a revenue database on an estimation server and the marketing investment vector data being stored in a marketing database on the estimation server. The set of data coefficients can be arranged 130 according to a magnitude of energy, as will be further explained below. Data coefficients having a magnitude of energy outside of a predetermined range can be identified 140 and eliminated 150 from the set of data coefficients to form a reduced coefficient set. The revenue vector data and the marketing investment vector data can be rebuilt 160 from the reduced coefficient set. As a result, a revenue estimation model can be created 170 for estimating revenues from the rebuilt revenue vector date and the marketing investment vector data. The revenue estimation model can provide a clearer view of revenue drivers from marketing investments by attenuating noise from the data.

Data compression is often performed using mathematical transformation methods. Mathematical transformations can enable the capture of details from the data while still representing the data in a parsimonious manner. The systems and methods for wavelet transform discussed provide flexible, reliable, and efficient data compressing via wavelets using correlation-based thresholding. Hard and soft thresholding methods are often used in data compression. The data compression or transformation in the present technology can emulate and outperform many of the hard and soft thresholding methods.

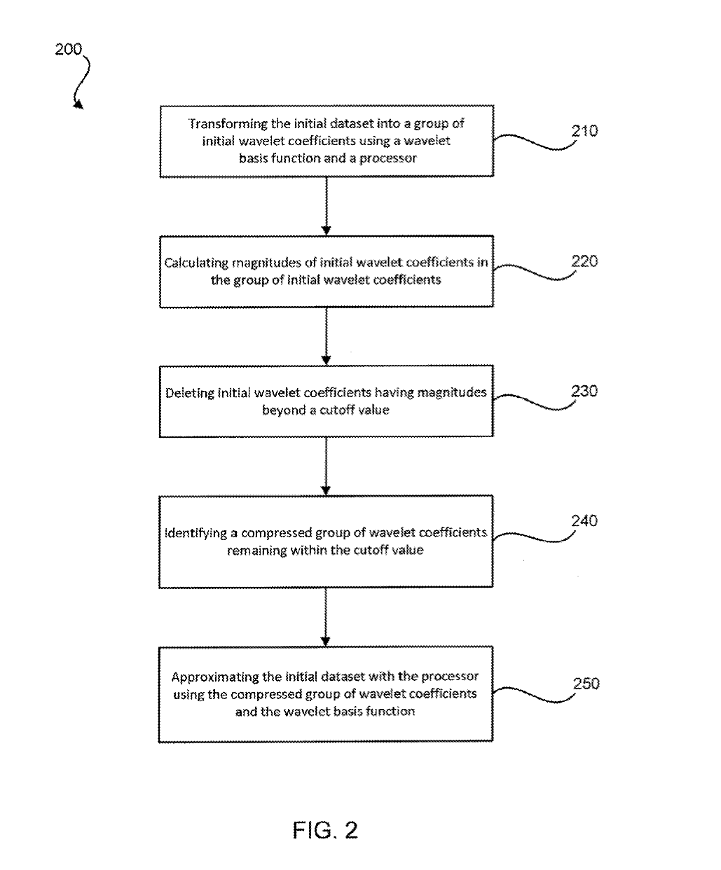

Reference will now be made to FIG. 2, in which a method 200 for compression of an initial dataset is illustrated. In the example described above for compressing an initial dataset using a data processing system, the data can be obtained from a database or from a non-transitory computer readable medium. In other words, an incoming data set Y can be provided. A wavelet transform W(Y) or a wavelet basis function, can be applied to the incoming data set to transform the data 210. For example, the wavelet transform can be applied using a processor in the data processing system. Application of the wavelet transform to the data set can result in a plurality of wavelet coefficients. In other words, the initial incoming dataset can be transformed into a group of initial wavelet coefficients using the wavelet transform.

Magnitudes of the initial wavelet coefficients in the group of initial wavelet coefficients can be calculated 220. These wavelet coefficients in the group can then be sorted in a descending order according to the coefficient magnitudes or energies. In one example, the cumulative squares of the coefficients (i.e., energy) can be plotted as a function of the number of coefficients. To a certain extent, the cumulative energy of a coefficient may vary as a function of a number of coefficients. Using the plotted data, coefficients can be identified and/or selected with a cumulative energy which does not change substantially with additional coefficients. For example, a user may desire to identify a subset of wavelet coefficients from the initial wavelet coefficients where the subset includes wavelet coefficients with energies within a predetermined range or cutoff value. In one example, the cutoff value or range can be based on an accuracy level for a resulting signal. In another aspect, the user can identify the subset based on a distribution of the wavelet coefficients. The user can select a percentile from the distribution, such as a small percentage of the distribution at one or both ends of the distribution, and eliminate or delete 230 the selected portion of the distribution. Typically the ends of the distribution comprise noise in the data. Thus, elimination of ends of the distribution can eliminate noise. Effectively, the elimination of the noise results in a compression of the data.

After the data has been compressed (i.e., the noise has been eliminated) a compressed group of wavelet coefficients can be identified 240 as the wavelet coefficients remaining within the cutoff value. The compressed group of wavelet coefficients comprises a subset of the initial set of wavelet coefficients. Because noise has been eliminated from the initial set of wavelet coefficients, the remaining subset can include more informative coefficients. The subset of the more informative coefficients can be used to reconstruct the original date (Y). In other words, the initial dataset can be approximated 250 using the compressed group of wavelet coefficients and the wavelet basis function. This effectively results in a decompression of the data.

After the data is decompressed and the initial dataset is approximated, a regression analysis can be performed on the approximation. While a regression analysis can be performed on the initial dataset, the noise in the data can provide misleading or confusing results.

The regression analysis may include any of a variety of techniques for modeling and analyzing several variables. More specifically, a focus of the regression analysis can be on the relationship between a dependent variable (such as revenue) and independent variables (such as various marketing investments). The regression analysts can aid in understanding how a value of the dependent variable changes when any one of the independent variables is varied while the other independent variables are held fixed. The regression analysis can be used in econometric modeling, such as prediction and forecasting. The regression analysis can also be used to understand which among the independent variables are related to the dependent variable, and to explore the forms of these relationships. In a more specific application, the regression analysis can be used to infer causal relationships between the independent and dependent variables.

In some examples, the coefficient cutoff value may comprise an average quantile of a group of bootstrap samples of wavelet coefficients. Accordingly, the group of initial wavelet coefficients can be bootstrap sampled to determine the group of bootstrap samples of wavelet coefficients. Each sample in the group of bootstrap samples can be transformed from the initial dataset to form the bootstrap sample of wavelet coefficients. Bootstrap sampling is described below.

Bootstrap sampling, or more simply bootstrapping, involves the estimation of properties of an estimator (such as its variance) by measuring those properties when sampling from an approximating distribution. In an example where a set of data is assumed to be from an independent and identically distributed population, bootstrapping can be implemented by constructing a number of resamples of the observed dataset (of equal size to the observed dataset), each of which is obtained by random sampling with replacement from the original dataset. As a more specific implementation, bootstrapping can be used to obtain alternative versions of a statistic ordinarily calculated from one sample. Bootstrapping can be used to derive estimates of standard errors and confidence intervals for complex estimators of complex parameters of a distribution, such as percentile points, proportions, odds ratio, and correlation coefficients.

In the context of econometric modeling, bootstrapping can be used to obtain alternative versions of revenue statistics. In one aspect, bootstrapping may be applied to the revenue data when an amount of available revenue data is insufficient to use effectively in a data transformation. The low amount of revenue data may be a result of a lack of recordkeeping, limited access to records, omission of certain records for various reasons, etc. Thus, according to this example, the revenue data represents a sample. In other aspects, the revenue data may comprise a sampled subset from a larger superset of data. In either example, typically one value of a statistic can be obtained from the sample. The statistic value may comprise a value such as a mean, a standard deviation, etc. As a result, determining how much the statistic actually varies can be difficult. When using bootstrapping, a new sample of n revenue data can be extracted out of N sampled data. By repeating such an extraction a number of times, a large number of datasets can be created which might have been available if a larger superset of data had been considered. Statistics can be computed for each of these extrapolated datasets, and estimation of the distribution of the statistics can be enabled.

As discussed, wavelet-based compression methods can be used for parsimoniously representing a distribution of data. These wavelet methods, including compression methods, can provide good estimates of data distributions through statistical estimation of wavelet coefficient distributions. Quantiles of the distribution can be estimated by sampling the distribution of the squares of the wavelet coefficients (i.e., the “energies” of the wavelet coefficients). Previous methods have proposed wave let-based compression, known as “selecting top B coefficients”. These prior methods select the top B coefficients by repeatedly adding and deleting coefficients and computing the reconstruction errors at each step. The present technology selects the coefficients differently.

For example, let x=(x₁, . . . , x_{N}) to be the data in a dataset. A wavelet transformation can be applied x, resulting in a vector of wavelet coefficients c=(c₁, . . . , c_{N}). The data x can be reconstructed from c by applying the inverse of the wavelet transformation. A compressed version of the coefficient vector c is defined as a vector of length N that matches c except that some of the coefficients are set to 0. Various methods can be used to create she compressed version of c. For example, the data can be de-noised using hard and soft thresholding to set all coefficients below a cutoff to 0 to shrink surviving coefficients toward 0. Another alternative is to keep the coefficients that contribute a predetermined proportion of the total energy. Another alternative keeps coefficients that are in the upper tail of the distribution of the squared-coefficients, in which the cutoff is estimated using bootstrapping as described above to estimate the relevant quantiles.

In some applications, a user may desire to know a number of wavelet coefficients to use to meet a predetermined level of accuracy (i.e., quality of reconstruction). This number of wavelet coefficients can be useful in estimating trade-offs between storage space and accuracy of reconstruction in various applications. A wavelet thresholding method is provided which enables data compression that meets a desired accuracy in rebuilding the data as specified by the user. Data compression can be desirable to address storage or computational burdens. While many methods exist to obtain data compression, these methods typically do not provide the flexibility to yield compression indexed to a predetermined. However, wavelet thresholding can be used to determine a number of coefficients to use by solving the kth term of a square summable sequence that provides desired accuracies.

The following discussion describes wavelet thresholding for use in econometric modeling and analysis. After a wavelet transform has been applied to a data set of marketing and/or revenue data, cumulative squares of the coefficients of the input data can be computed. The squares of the coefficients represent the energy or magnitude of energy of the wavelets coefficients. A total energy T can be computed as a sum of the energies. A desired accuracy level can be selected, such as ε=(1%, 2%, . . . ). The difference Δ between the total energy T and the cumulative sum of squares can be computed iteratively. The value of an unknown variable k in the upper limit of the sum can be found such that the difference Δ is less than or equal to ε. The k coefficients can then be used to rebuild the original data using an inverse wavelet transform. The resulting reconstructed dataset will match the initial dataset with a correlation equal to ε. Thus, for example, if an accuracy of ε=1% is desired, an appropriate number of coefficients k to keep within the subset of coefficients during compression, can be determined, and the resulting dataset will match the initial dataset within an accuracy of 1%.

Table 1 below illustrates a number of coefficients to use in the example datasets for predefined levels of desired accuracy.

TABLE I

| | | | Desired | Number of |
|---|---|---|---|---|
| Distribution | Wavelet | n | Accuracy | Coefficients |
| Doppler | Db1 | 16 | 5% | 9 |
| Doppler | Db1 | 16 | 10% | 7 |
| Doppler | Db1 | 32 | 5% | 16 |
| Doppler | Db1 | 32 | 10% | 12 |
| Doppler | Db1 | 64 | 5% | 24 |
| Doppler | Db1 | 64 | 10% | 16 |
| Doppler | Db1 | 128 | 5% | 36 |
| Doppler | Db1 | 128 | 10% | 24 |
| Doppler | Db1 | 256 | 5% | 43 |
| Doppler | Db1 | 256 | 10% | 26 |
| Doppler | Db1 | 512 | 5% | 44 |
| Doppler | Db1 | 512 | 10% | 26 |

The example illustrated in Table 1 uses data from a Doppler distribution and the application of a Db1 wavelet transform. For various sample sizes n, the table illustrates a number of coefficients k to use to achieve the desired accuracy ε. For example, 44 coefficients would be used to achieve a 5% accuracy at a sampling rate of 512 using the Db1 wavelet transform. At 10% accuracy, the number of coefficients is 26.

Example usage of the above described bootstrapping and thresholding methods in terms of wavelet transformation of data used in econometric modeling is described below.

A database may be provided for storing data used in econometric modeling. For example, the database may comprise revenue data, marketing investment data, and other types of data. In this example, let y₁=[y₁,y₂, . . . , y_{N}] represent revenue data for a period of n months. Let X=[X₁,X₂, . . . , Xₖ] represent marketing investment date over various forms of advertising k. For instance, Xᵢ can represent print marketing, X₂ can represent television marketing, X₃ can represent event marketing, and so forth. In one aspect, X can represent marketing investment data over various forms of advertising over the same time period n months, or over a different time period. For example, the effect of a marketing investment on revenue may not be realized for a period of time after the marketing investment. Also, accounting for a businesses marketing investment practices may result in use of a different time period than the period used for revenue data. For instance, some businesses will appropriate funds for various marketing investments in advance of when the funds are actually spent.

A wavelet basis function can be selected to apply to at least one of the marketing and revenue datasets. The basis function can be used to generate an entire vector space, where each vector is a linear combination of the initial dataset and the basis function. The wavelet basis function can be represented as φ={φ₁, φ₂, . . . φₙ}. A wavelet transform, or the linear combination forming the vector, can be represented as <y, φ>. In one aspect, the wavelet transform or wavelet basis function can be a discrete wavelet transform (DWT). A DWT is any wavelet transform for which the wavelets are discretely sampled. As with other wavelet transforms, the DWT can provide temporal resolution by capturing both frequency and location information (location in time). Examples of DWTs include the Haar wavelet transform or the Daubechies wavelet transform.

Upon selection and application of the wavelet basis function to the selected initial dataset(s), a group of initial wavelet coefficients can be produced. The group of initial wavelet coefficients can be represented as [w₁, w₂, w₃, . . . , w_{N}], where n represent the number of data points. In other words, n wavelet coefficients can be produced for n data points. In one aspect, the wavelet coefficients can be produced using the following formulae. In computing wavelet coefficients for revenue, the formula:

$$Y = {\sum }_{i = 1}^{n} {w}_{i} {ϕ}_{i}$$

can be used. In computing wavelet coefficients for marketing data, the following formula can be used:

$${X}_{ij} = {\sum }_{i = 1}^{n} {w}_{ij} {ϕ}_{i} , j = 1 , 2 , … , k .$$

Once the group of initial wavelet coefficients has been obtained, the wavelet coefficients in the group can be arranged according to order of magnitude of energy. As described above, the energy of a wavelet coefficient can be obtained by the square of the coefficient, and the energy can represent information in the coefficient about the underlying data. At this point, the smoothing or wavelet thresholding method can be used to determine how many wavelet coefficients to include in a subset of wavelet coefficients, based on a desired accuracy of a final approximated dataset. Also, the bootstrapping method can be used to set a threshold for a cutoff value by sampling the coefficients and building a distribution of the coefficients. A portion of the distribution can be cut off to eliminate noise from a signal in the underlying data. Wavelet coefficients which are retained can be selected based on cumulative energy (wavelet inner products). Wavelet coefficients which are not retained can be discarded or disregarded from further consideration.

The remaining wavelet coefficients can form a subset of the initial group of wavelet coefficients. The subset of wavelet coefficients can be represented in a similar manner as the initial group of wavelet coefficients, such as [w₁,w₂,w₃, . . . , wₖ], where k<n or even k<<n. Though the example representation of the subset of wavelet coefficients includes w₁, w₂, and w₃, these wavelets may or may not be the same as the w₁, w₂, and w₃ in the initial group because some of the wavelets have been removed.

Use of an inverse discrete wavelet transform (IDWT) can rebuild the dataset. For example, the initial revenue data vector yᵢ=[y₁y₂, . . . , yₙ] can be rebuilt and approximated using the subset of coefficients and the IDWT to form, an approximation of yᵢ as yᵢ*=[y₁*,y₂, . . . , yₙ*]. Similarly, an approximation of X can be rebuilt using the subset of coefficients and the IDWT to achieve the approximated vector X*=[X₁*,X₂*, . . . Xₖ*].

In a further example, the rebuilt data vectors can be fit to the original data using a least squares fit. More specifically, yᵢ* can be fit to the original data yᵢ using the formula:

$${y}_{i}^{*} = α + {\sum }_{i = 1}^{n} {β}_{i} {x}_{i}^{*} + {e}^{i}$$

Where eⁱ represents the error between the actual data yᵢ and the approximated data yᵢ*, α can be estimated by applying the ordinary least squares method and β can be selected to fit the curve of the data yᵢ.

The rebuilt data vectors contain less noise than the original data vectors and a signal in the data indicating marketing drivers of revenue can be extracted using a regression analysis.

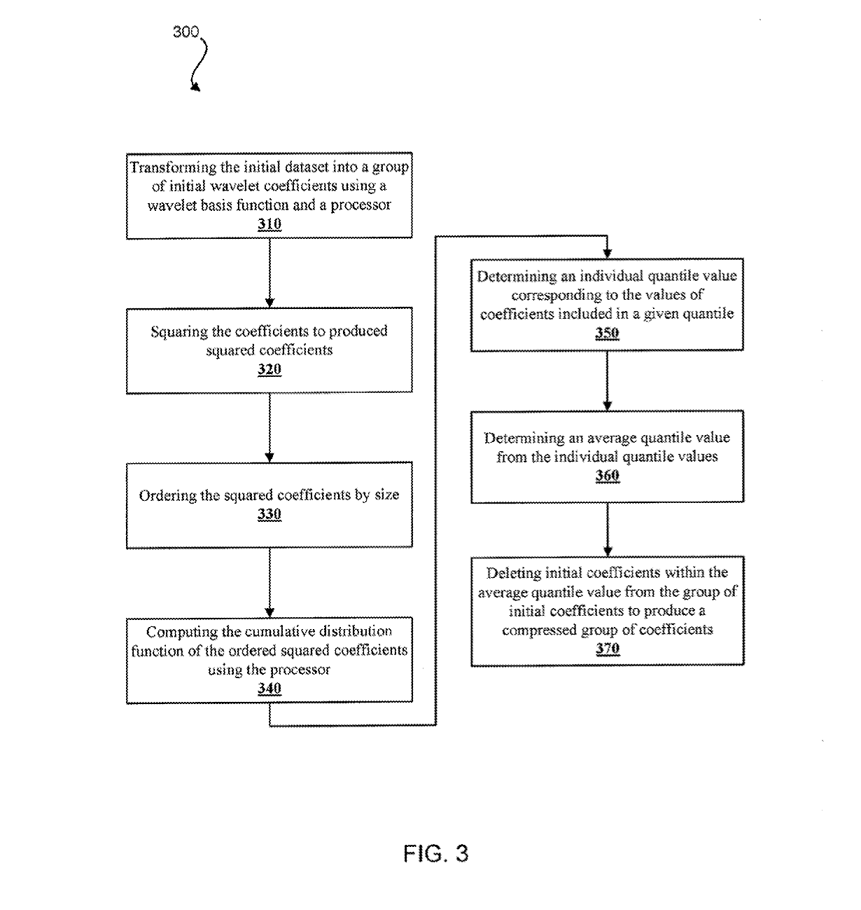

In the example shown in FIG. 3, a method 300 is provided for compressing an initial dataset stored on a non-transitory computer readable storage medium. The method can be implemented on a data processing system. The method can include transforming 310 the initial dataset into a group of initial wavelet coefficients using a wavelet basis function and a processor. The coefficients can be squared 320 to produced squared coefficients. The squared coefficients can be ordered 330 by size. The cumulative distribution function of the ordered squared coefficients can be computed 340 using the processor. An individual quantile value corresponding to the values of coefficients included in a given quantile can be determined 350, 360, as well as an average quantile value from the individual quantile values. Initial coefficients within the average quantile value can be deleted 370 or removed from the group of initial coefficients to produce a compressed group of coefficients.

In a further example, transforming the initial dataset may further comprise transforming the initial dataset into a group of initial coefficients using a wavelet basis function and bootstrap sampling the group of coefficients to form sampled sets of coefficients. Also, the transformation of the initial dataset may further comprise transforming each of a plurality of bootstrapped samples of the dataset into respective sets of coefficients.

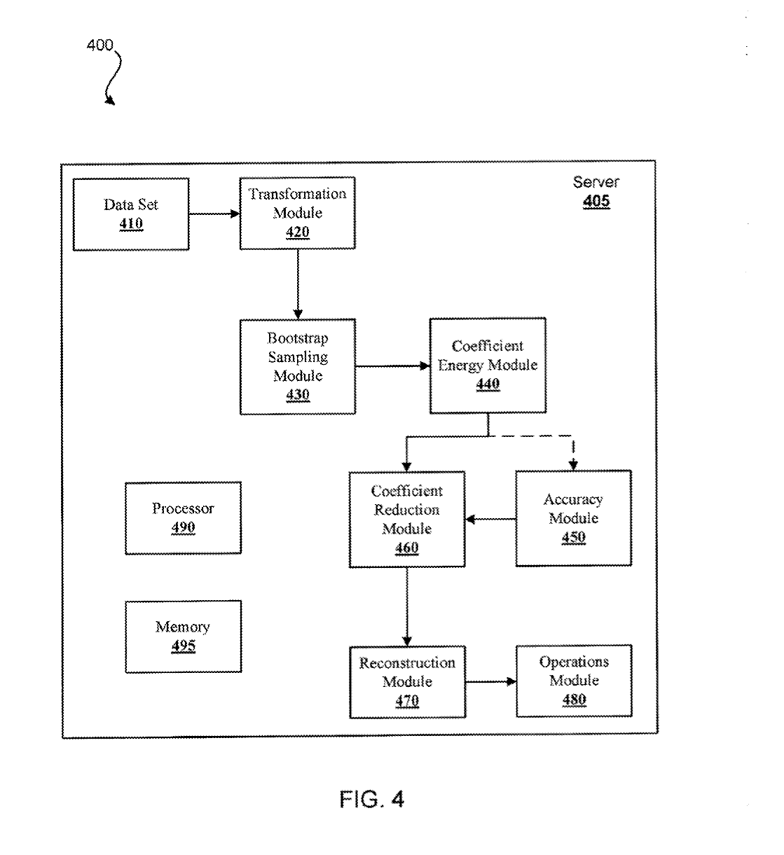

FIG. 4 illustrates a data processing computer system 400 for compressing an initial dataset 410 stored on a non-transitory computer readable medium in accordance with an example. The initial dataset can include econometric modeling data, such as revenue vector data and marketing investment vector data. The system includes a transformation module 420 for transforming the initial dataset into a group of initial wavelet coefficients using a wavelet basis function and a processor. A bootstrap sampling module 430 forms a sampled set of wavelet coefficients from the group of initial wavelet coefficients. A coefficient energy module 440 can arrange the sampled set of wavelet coefficients according to a magnitude of energy of the wavelet coefficients. The coefficient energy module can compute the magnitude of energy of the wavelet coefficients by cumulatively computing a sum of squares of the wavelet coefficients. Also, the coefficient energy module can compute a total energy of the group of initial wavelet coefficients. An accuracy module 450 can provide an accuracy value and to compute a difference between the magnitude of energy of the wavelet coefficients and the total energy of the group of initial wavelet coefficients.

A coefficient reduction module 460 can identify and eliminate wavelet coefficients from the sampled set of wavelet coefficients which have a magnitude of energy outside of a predetermined range to form a reduced coefficient set. The coefficient reduction module can also eliminate wavelet coefficients outside of the predetermined range defined by the accuracy value. As described above, the wavelet coefficients to eliminate can be wavelet coefficients where the difference between the magnitude of energy of the wavelet coefficients and the total energy of the group of initial wavelet coefficients is greater than the accuracy value. A reconstruction module 470 can form a reconstructed dataset from the reduced coefficient set, where the reconstructed dataset comprises a compression of the initial dataset. For example, the reconstructed dataset may comprise reconstructed revenue vector data and/or reconstructed marketing investment data. An operations module 480 can perform an operation on the reconstructed dataset. The system can also include a revenue estimation module for estimating projected revenues from the reconstructed revenue vector data and the reconstructed marketing investment vector data based on projected future marketing investments.

The system can be implemented on a personal computer, a server 405, or other suitable computing or processing device. The server can include a processor 490, memory 495, buses, peripheral devices, network connections, a computer-readable storage medium, and other devices or components which may be useful in operating the system. For example, the various modules can use the processor, memory, etc. in performing various operations or methods. As another example, a database can be maintained on the computer-readable storage medium from which the initial dataset can be obtained.

The systems and methods described above can provide pre-processing of business data by wavelets to eliminate noise in the data while retaining a signal that enables reliable statistical modeling. Whereas classical regression analysis attempts to eliminate outliers after fitting data to a model, outliers according to the present application can be highlighted by wavelet coefficients, enabling the system to provide a strong diagnostic or reliable predictor.

The methods and systems of certain embodiments maybe implemented in hardware, software, firmware, machine-readable instructions, and combinations thereof. In one embodiment, the method can be executed by software or firmware that is stored in a memory and that is executed by a suitable instruction execution system. If implemented in hardware, as in an alternative embodiment the method can be implemented with any suitable technology that is well known in the art.

Also within the scope of an embodiment is the implementation, of a program or code that can be stored in a non-transitory machine-readable storage medium to permit a computer to perform any of the methods described above.

Some of the functional units described in this specification have been labeled as modules, in order to more particularly emphasize their implementation independence. The various modules, engines, tools, or modules discussed herein may be, for example, software, firmware, commands, data files, programs, code, instructions, or the like, and may also include suitable mechanisms. For example, a module maybe implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

While the forgoing examples are illustrative of the principles of the present technology in particular applications, it will be apparent that numerous modifications in form, usage and details of implementation can be made without the exercise of inventive faculty, and without departing from the principles and concepts of the technology. Accordingly it is not intended that the technology be limited, except as by the claims set forth below.

1. A method (200) for compressing an initial dataset, the method being implemented on a data processing system and comprising:
transforming (210) the initial dataset into a group of initial wavelet coefficients using a wavelet basis function and a processor;
calculating (220) magnitudes of initial wavelet coefficients in the group of initial wavelet coefficients;
deleting (230) initial wavelet coefficients having magnitudes beyond a cutoff value;
identifying (240) a compressed group of wavelet coefficients remaining within the cutoff value; and
approximating (250) the initial dataset with the processor using the compressed group of wavelet coefficients and the wavelet basis function to form an approximated dataset.

2. The method according to claim 1, wherein the coefficient cutoff value comprises the average quantile of a group of bootstrap samples of wavelet coefficients.

3. The method according to claim 2, further comprising bootstrap sampling the group of initial wavelet coefficients to determine the group of bootstrap samples of wavelet coefficients.

4. The method according to claim 2, further comprising transforming each of a group of bootstrap samples from the initial dataset to form the bootstrap sample of wavelet coefficients.

5. The method according to claim 1, further comprising performing a regression analysis on the approximated dataset.

6. The method according to claim 1, wherein:
the initial dataset comprises revenue vector data and marketing investment vector data;
the approximated dataset comprises reconstructed revenue vector data and reconstructed marketing investment vector data.

7. A data processing computer system (400) for compressing an initial dataset (410) stored on a non-transitory computer readable medium, comprising:
a transformation module (420) configured to transform the initial dataset into a group of initial wavelet coefficients using a wavelet basis function and a processor;
a bootstrap sampling module (430) configured to form a sampled set of wavelet coefficients from the group of initial wavelet coefficients;
a coefficient energy module (440) configured to arrange the sampled set of wavelet coefficients according to a magnitude of energy of the sampled set of wavelet coefficients;
a coefficient reduction module (460) configured to identify and eliminate wavelet coefficients from the sampled set of wavelet coefficients which have a magnitude of energy outside of a predetermined range to form a reduced coefficient set;
a reconstruction module (470) configured to form a reconstructed dataset from the reduced coefficient set, the reconstructed dataset comprising a compression of the initial dataset; and
an operations module (480) configured to perform a regression analysis on the reconstructed dataset.

8. A system as in claim 7, wherein the coefficient energy module is configured to compute the magnitude of energy of the wavelet coefficients by cumulatively computing a sum of squares of the wavelet coefficients.

9. A system as in in claim 8, wherein the coefficient energy module is configured to compute a total energy of the group of initial wavelet coefficients.

10. A system as in claim 9, further comprising an accuracy module (450) configured to provide an accuracy value and to compute a difference between the magnitude of energy of the wavelet coefficients and the total energy of the group of initial wavelet coefficients.

11. A system as in claim 10, wherein the coefficient reduction module is configured to eliminate wavelet coefficients outside of the predetermined range defined by the accuracy value, wherein the wavelet coefficients to eliminate are wavelet coefficients where the difference between the magnitude of energy of the wavelet coefficients and the total energy of the group of initial wavelet coefficients is greater than the accuracy value.

12. A system as in claim 7, wherein:
the initial dataset comprises revenue vector data and marketing investment vector data;
the reconstructed dataset comprises reconstructed revenue vector data and reconstructed marketing investment vector data; and
the system further comprises a revenue estimation module for estimating revenues from the reconstructed revenue vector data and the reconstructed marketing investment vector data.

13. A method (100) for estimating revenues based on marketing investments, comprising:
computing (120) a set of data coefficients for revenue vector data and marketing investment vector data using a processor based on a selected (110) set of wavelet transforms, the revenue vector data being stored in a revenue database on an estimation server and the marketing investment vector data being stored in a marketing database on the estimation server;
arranging (130) the set of data coefficients according to a magnitude of energy;
identifying (140) data coefficients having a magnitude of energy outside of a predetermined range;
eliminating (150) the data coefficients having the magnitude of energy outside of the predetermined range from the set of data coefficients to form a reduced coefficient set;
rebuilding (160) the revenue vector data and the marketing investment vector data from the reduced coefficient set; and
creating (170) a revenue estimation model for estimating revenues from the rebuilt revenue vector data and the marketing investment vector data.

14. The method according to claim 13, wherein computing a set of data coefficients comprises computing a set of data coefficients using a wavelet basis junction and bootstrap sampling the group of coefficients to form sampled sets of coefficients.

15. The method according to claim 13, wherein computing a set of data coefficients further comprises thresholding the set of data coefficients according to a predetermined accuracy level and bootstrap sampling the set of data coefficients to determine the predetermined range.
